(19) United States
(12) Patent Application Publication
(10) Pub. No.: US 2024/0221434 A1
(43) Pub. Date: Jul. 4, 2024

(54) SYSTEMS AND METHODS FOR MULTI-SOURCE VEHICLE WEAR AND MAINTENANCE DETECTION USING MACHINE LEARNING TECHNIQUES

(71) Applicant: Cameron P. Mitchell, Danville, CA (US)

(72) Inventor: Cameron P. Mitchell, Danville, CA (US)

(21) Appl. No.: 18/148,753

(22) Filed: Dec. 30, 2022

(51) Int. Cl. G07C 5/00; G07C 5/08

(52) U.S. Cl. CPC G07C 5/006; G07C 5/008; G07C 5/0816

(57) ABSTRACT

A system described herein may provide a technique for determining a measure of wear and tear on a vehicle as well as one or more actions to take, such as increased maintenance and/or particular types of maintenance or repairs. The system may maintain models associating vehicle input information with respective vehicle wear classifications, and may receive vehicle input information associated with a particular vehicle, including sensor data measured by a User Equipment (“UE”), and/or vehicle information provided by the particular vehicle. The system may compare the received particular set of vehicle input to the models and may determine, based on the comparing, a vehicle wear classification associated with the particular vehicle. The system may identify one or more actions associated with the determined one or more vehicle wear classifications; and may output, to the UE, information indicating the identified one or more actions.

### BACKGROUND

Vehicles, such as cars, trucks, etc. may be equipped with on-board diagnostics and/or telematics monitoring equipment. Such vehicles may make diagnostic and/or telematic information available via an on-board diagnostics (“OBD”) port, such as an OBD port conforming to an OBD-II standard. User Equipment (“UEs”), such as mobile phones, may have wireless communication capability, such that UEs are able to wirelessly communicate with servers or other devices via a wireless network.

### BRIEF DESCRIPTION OF THE DRAWINGS

FIG. 1 illustrates an example overview of one or more embodiments described herein;

FIG. 2 illustrates an example of determining a measure of vehicle wear and tear based on one or more sources of vehicle information and/or other types of information, in accordance with some embodiments;

FIG. 3 illustrates an example set of wear models that may be used to determine a measure of vehicle wear and tear based on vehicle input information, in accordance with some embodiments;

FIGS. 4 and 5 illustrate example user interfaces that may be used to present actions, recommendations, and/or other information regarding determined measures of vehicle wear, in accordance with some embodiments;

FIG. 6 illustrates an example process for using one or more models to determine a measure of vehicle wear and tear based on vehicle information and/or other types of information, in accordance with some embodiments;

FIG. 7 illustrates an example environment in which one or more embodiments, described herein, may be implemented;

FIG. 8 illustrates an example arrangement of a radio access network (“RAN”), in accordance with some embodiments; and

FIG. 9 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

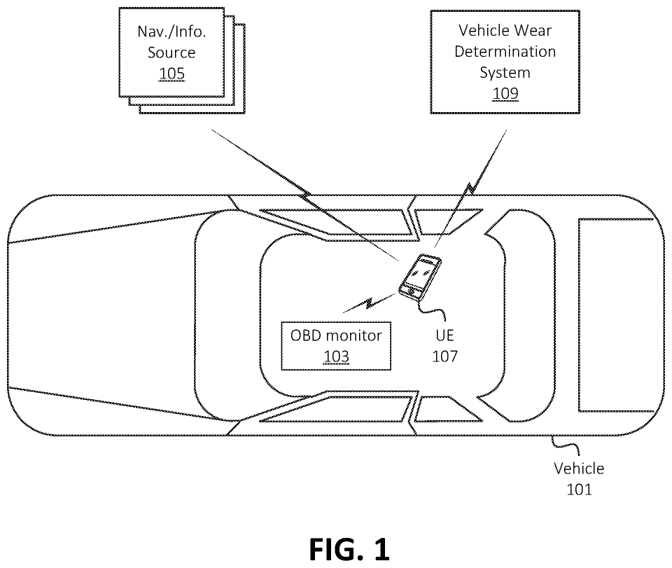

Embodiments described herein provide for the monitoring of vehicle usage patterns in order to determine measures of wear, abuse, etc. to which vehicles are subjected. As shown in FIG. 1, embodiments described herein may, for example, receive vehicle-related data associated with a given vehicle 101 from multiple sources, such as from an OBD monitor 103 communicatively coupled to vehicle 101, navigation and/or information source 105, UE 107 (e.g., sensor data collected by UE 107 located within vehicle 101 while vehicle 101 is operating), and/or other suitable sources. Vehicle Wear Determination System 109 may, for example, receive some or all of the above-mentioned information (e.g., from UE 107 via a wireless network), and may determine metrics, classifications, actions, recommendations, alerts, etc. related to wear and tear, degradations, etc. (referred to herein simply as “wear” for the sake of clarity) based on the received information.

Generally, for example, a vehicle that is “driven harder,” such as with relatively high measures of acceleration or braking, more severe lateral forces (e.g., sharper and/or faster turns), with more engine ignitions, more “stop and go” traffic, more steep ascent and/or decline angles, etc. may experience greater measures of wear than vehicles that are driven more conservatively, less frequently, etc. A driver, owner, an insurer, etc. of such vehicle may desire to gain insight as to how worn the vehicle is becoming, as performing maintenance and/or repairs may be costly, or otherwise advisable to keep the vehicle in safe, working order. As discussed below, Vehicle Wear Determination System 109 may utilize artificial intelligence/machine learning (“AI/ML”) techniques or other suitable techniques in order to train models based on which Vehicle Wear Determination System 109 may identify how worn vehicle 101 is becoming, may identify specific types of wear on vehicle 101 (e.g., engine wear, tire wear, brake wear, electrical system wear, etc.), and/or may identify remedial actions based on identifying measures of wear on vehicle 101. As discussed below, remedial actions may include recommending different driving habits in order to reduce wear, recommending different driving routes in order to reduce wear, recommending specific types of maintenance or repairs to perform in order to repair or replace worn parts, modifying service intervals, and/or other suitable actions.

As another example, the actions may include reporting measures of wear to a governmental agency, such as a local or state agency that enforces periodic (e.g., annual) safety inspections, where reporting relatively minimal wear (or wear below a threshold) may place vehicle 101 in compliance for a particular period. For instance, vehicle 101 may “pass an annual inspection” based on information determined and provided by Vehicle Wear Determination System 109. As another example, the actions may include reporting measures of wear to a bank, lender, car dealer, etc., which may set or modify a value of the vehicle based on the determined measure of wear (e.g., less worn vehicles may be in “good” or “excellent” condition, based on which the value of such vehicles may be higher than vehicles that are in “fair” or “poor” condition).

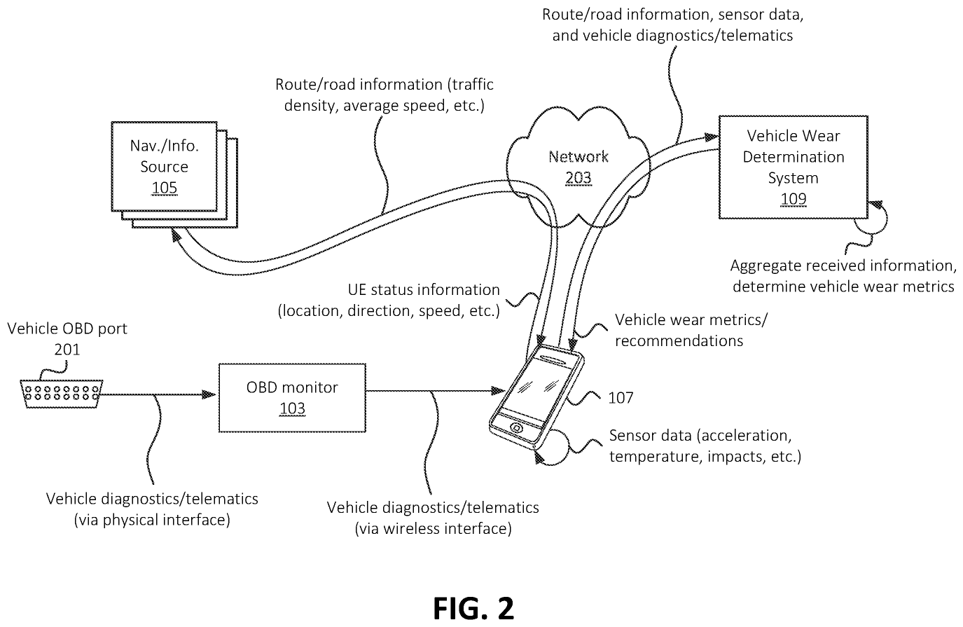

FIG. 2 illustrates an example of monitoring and/or collecting information based on which Vehicle Wear Determination System 109 may determine a measure of wear of vehicle 101. As shown, OBD monitor 103 may receive vehicle diagnostics, telematics, and/or other information (referred to herein simply as “vehicle information” for the sake of simplicity) via OBD port 201. OBD monitor 103 may implement the same interface, communication protocol(s), etc. as vehicle OBD port 201. For example, vehicle OBD port 201 and OBD monitor 103 may implement an OBD-II standard, or other suitable standard or protocol, via which vehicle OBD port 201 outputs vehicle information to OBD monitor 103. In some embodiments, OBD monitor 103 may include a physical mating apparatus, adapter, plug, etc. that physically interfaces with (e.g., “plugs into”) vehicle OBD port 201. In some embodiments, OBD monitor 103 and vehicle OBD port 201 may communicate in come other suitable manner, such as via one or more intervening interfaces or communication devices.

In some embodiments, such vehicle information may include vehicle attributes or parameters, such as make, model, year, vehicle information number (“VIN”), vehicle type (e.g., sedan, truck, etc.), and/or other information pertaining to attributes of vehicle 101. In some embodiments, vehicle information provided by vehicle OBD port 201 may include historical and/or logged information, such as error codes, mileage traveled, events, alerts, drive cycles since last error code reset, average trip duration (e.g., average duration between starting and stopping an engine of vehicle 101), “redline” incidences (e.g., quantity of occurrences that an engine of vehicle 101 has met or exceeded a threshold number of rotations per minute (“RPMs”)), and/or other such information. In some embodiments, vehicle information provided via vehicle OBD port 201 may include real-time diagnostics, such as current mileage, fuel level, battery voltage, throttle inputs, braking inputs, steering inputs, vehicle climate system operational status (e.g., temperature, fan speed, etc. of air vents within vehicle 101), electrical system current draw (e.g., which may indicate components or systems of vehicle 101 that are drawing electrical current, such as a battery, a power outlet within a cabin of vehicle 101, etc.), and/or other real-time diagnostics. In some embodiments, the vehicle information may include service and/or maintenance information, which may be based on inputs provided by a technician during a vehicle service visit, such as dates of maintenance or repairs, types of maintenance or repairs performed, etc. In some embodiments, vehicle OBD port 201 may provide other types of information in addition to, or in lieu of, the examples provided above.

OBD monitor 103 may, in some embodiments, include wireless communication circuitry (e.g., utilizing Bluetooth, WiFi, and/or some other suitable wireless communication technology) via which OBD monitor 103 may provide some or all of the received vehicle information (e.g., as received from vehicle 101 via vehicle OBD port 201) to UE 107. For example, UE 107 may be “paired with” or otherwise communicatively coupled to OBD monitor 103 via a wireless interface. Additionally, or alternatively, UE 107 and OBD monitor 103 may communicate via physical communication pathway, such as via a wire, cable, universal serial bus (“USB”) port, etc. In some embodiments, some or all of the functionality described herein with respect to OBD monitor 103 may be performed by UE 107. For example, in some embodiments, UE 107 may include and/or may be communicatively coupled to a cable, interface, adapter, etc. via which UE 107 may receive vehicle information from vehicle 101 via vehicle OBD port 201. In some embodiments, UE 107 may execute an application, application programming interface (“API”), and/or other suitable communication mechanism by which UE 107 receives and maintains the vehicle information provided via vehicle OBD port 201.

UE 107 may, as shown, further collect sensor data, which may be collected, measured, etc. by one or more sensors or other suitable devices that are integrated within or are otherwise communicatively coupled to UE 107. For example, UE 107 may include one or more accelerometers, gyroscopes, barometers, thermometers, hydrometers, microphones, photosensors, etc. via which UE 107 may collect or measure sensor data. Such sensor data may include raw data, such as raw values measured or recorded by such sensors. Additionally, or alternatively, the sensor data may include processed and/or classified data, which may be determined by UE 107 (e.g., by an application executing on UE 107) and/or some other suitable device or system (e.g., a remote application server that processes the sensor data using AI/ML techniques or other suitable techniques). Assume, for example, that the processed and/or classified data includes impact detection. The impact detection may be determined by UE 107 and/or some other suitable device or system based on accelerometer data and/or other suitable sensor data. For example, one or more models that indicates or predicts impacts based on such data may be compared to sensor data (e.g., accelerometer data) collected by UE 107, and a match between such models and the accelerometer data may indicate that an impact occurred, a likely severity of the impact (e.g., low, medium, severe, etc.), a potential object with which the impact occurred (e.g., speed bump, another vehicle, wildlife, etc.), and/or other classifications. In other examples, UE 107 may determine other types of events, classifications, etc. determined based on sensor data collected or measured by one or more sensors associated with UE 107. In this sense, the “sensor data” discussed with respect to UE 107 may include raw sensor data values, and may further include processed or categorized information based on raw sensor data values.

In some embodiments, UE 107 may collect, maintain, generate, etc. other types of information in addition to the sensor data discussed above. For example, in some embodiments, UE 107 may maintain or receive location information, such as a geographical location (e.g., latitude and longitude coordinates, Global Positioning System (“GPS”) coordinates, etc.) of UE 107. In some embodiments, UE 107 may determine its own location, and/or may receive its location from a wireless network to which UE 107 is connected (e.g., a Long-Term Evolution (“LTE”) network, a Fifth Generation (“5G”) network, etc.). As another example, UE 107 may maintain information associated with one or more users, which may be associated with a driver profile (e.g., where a user of UE 107 may also be a driver of vehicle 101). In some embodiments, UE 107 may maintain other types of information that may ultimately be used in determining a measure of wear on vehicle 101.

In some embodiments, UE 107 may communicate with Navigation/Information Source 105, which may provide navigation instructions, traffic information, road condition information, and/or other information to UE 107. For example, UE 107 may execute an application that receives or determines a destination of vehicle 101 (e.g., a user of UE 107 and/or of vehicle 101 may specify the destination in a navigation request), and communicates with Navigation/Information Source 105, which may provide navigation directions from a specified starting point (e.g., a present location of UE 107) to the destination. In order to determine the navigation directions, Navigation/Information Source 105 may have access to traffic information, emergency alerts, indicating traffic density, road closures, accidents, average speed of vehicles on a given roadway, etc. In some embodiments, Navigation/Information Source 105 may provide some or all of such information to UE 107 (e.g., information pertaining to a navigation route requested via UE 107, and/or information otherwise pertaining to roads on which vehicle 101 is traveling or has traveled).

UE 107 may provide some or all of the above-discussed information (e.g., vehicle information received from vehicle 101 via vehicle OBD port 201, sensor data collected or measured by UE 107 and/or by one or more devices (e.g., wearable devices or other separate devices) that are communicatively coupled to UE 107, and/or road/route information provided by Navigation/Information Source 105) to Vehicle Wear Determination System 109. UE 107 may provide such information via network 203, which may be an LTE network, a 5G network, and/or some other suitable type of wireless network. In some embodiments, UE 107 may be communicatively coupled to a WiFi “hotspot” or other type of access point integrated in vehicle 101, and may communicate with Vehicle Wear Determination System 109 via network 203 by way of such hotspot.

UE 107 may, in some embodiments, record sensor data, request or receive road/route information from Navigation/Information Source 105, and/or perform other operations based on detecting that UE 107 is present within vehicle 101 and/or that vehicle 101 is in motion, is operational (e.g., an engine and/or electrical system is powered on). For example, UE 107 may detect that UE 107 is present within vehicle 101 and/or that vehicle 101 is operational based on connecting to one or more vehicle systems, such as a wireless infotainment system (e.g., using Bluetooth, WiFi, and/or some other wireless technique). Additionally, or alternatively, UE 107 may detect that UE 107 is present within vehicle 101 and/or that vehicle 101 is operational based on connecting to OBD monitor 103 and/or vehicle OBD port 201, and/or based on information received via vehicle OBD port 201 (e.g., information indicating an operational status of vehicle 101). In this manner, UE 107 may be able to collect, aggregate, etc. information that is relevant to determining measures of wear on vehicle 101, without mixing such information with other, potentially irrelevant information (e.g., sensor data and/or other information collected or received by UE 107 while UE 107 is outside of vehicle 101).

Vehicle Wear Determination System 109 may aggregate the information received from UE 107, in order to gain a “big picture” analysis of information that may indicate how to what extent vehicle 101 is being subjected to factors that may contributed to wear on vehicle 101. For example, Vehicle Wear Determination System 109 may “stitch together” some or all of the received information in order to determine time-based and/or location-based insights as to what types of events, usage patterns, etc. vehicle 101 is experiencing. For example, Vehicle Wear Determination System 109 may identify, based on a location of vehicle 101 (e.g., as determined by UE 107 and/or Navigation/Information Source 105), traffic density information (e.g., as provided by Navigation/Information Source 105), throttle and/or braking information (e.g., as provided by vehicle 101 via vehicle OBD port 201), motion and/or acceleration sensor data (e.g., as collected by UE 107), etc. that vehicle 101 is experiencing a relatively high measure of wear during certain times. For example, the location information and/or road/route information, along with an associated timestamp, may indicate that vehicle 101 is located on a relatively busy stretch of road (e.g., relatively high traffic density, relatively low average speed relative to a speed limit of the road, etc.) during a relatively busy time (e.g., “rush hour”). The throttle and/or braking information (and/or other vehicle telematics) may indicate that vehicle 101 is braking relatively frequently (e.g., within 10 seconds of a throttle being applied). The sensor data collected by UE 107 may indicate that vehicle 101 is starting and stopping relatively abruptly (e.g., short, quick bursts of acceleration or deceleration). As discussed below, Vehicle Wear Determination System 109 may compare the received information to one or more models, and may determine that vehicle 101 is experiencing relatively high levels of wear during such times based on comparing the aggregated data to one or more wear models.

As another example, Vehicle Wear Determination System 109 may receive vehicle information indicating that a climate system of vehicle 101 is frequently turned on while the engine of vehicle 101 is turned off. Vehicle Wear Determination System 109 may determine (e.g., based on one or more models, as discussed below) that this type of usage may contribute to excessive battery wear.

As yet another example, Vehicle Wear Determination System 109 receive sensor data (e.g., as measured or collected by UE 107) and road/route information (e.g., from Navigation/Information Source 105), based on which Vehicle Wear Determination System 109 may determine that tires of vehicle 101 are wearing unevenly, or in some other abnormal manner. For example, Vehicle Wear Determination System 109 may receive acceleration or motion information (e.g., as collected by one or more accelerometers of UE 107) indicating relatively high lateral forces, and may receive road/route information (e.g., as provided by Navigation/Information Source 105) indicating that vehicle 101 is traveling on relatively windy roads while such forces are being measured by UE 107. If vehicle 101 routinely exhibits such behaviors, this may indicate that tires of vehicle 101 are experiencing greater rates of wear than tires of vehicles that are driven in a different manner (e.g., with lower lateral forces, on straighter roads, etc.).

As still another example, Vehicle Wear Determination System 109 may receive sensor data (e.g., as measured or collected by UE 107) and road/route information (e.g., from Navigation/Information Source 105), based on which Vehicle Wear Determination System 109 may determine that vehicle 101 has impacted obstacles, potholes, or other objects while traveling along a road. For example, accelerometer and/or impact detection information (e.g., as measured and/or determined by UE 107) may indicate one or more impacts at a particular time. Location information associated with UE 107 may indicate that vehicle 101 was located on a particular road or at a particular location at the same time. Further, road/route information may indicate that the particular road or location is associated with a construction zone, that debris or objects on the road have been reported, and/or that other road conditions are present on the particular road or at the particular location. In such an instance, Vehicle Wear Determination System 109 may determine that vehicle 101 has experienced a relatively high amount of wear to suspension components of vehicle 101 (e.g., shocks, struts, etc.).

As yet another example, Vehicle Wear Determination System 109 may receive vehicle information (e.g., via vehicle OBD port 201) and sensor data (e.g., as measured or collected by UE 107), based on which Vehicle Wear Determination System 109 may determine that vehicle 101 has traveled on dirt or gravel roads, and therefore has experienced extra levels of wear by virtue of such events. For example, vehicle information may indicate that vehicle 101 has issued a lane departure warning (e.g., in the event that vehicle 101 is equipped with sensors or other devices that are able to detect and report when vehicle 101 has veered out of a lane or has otherwise departed the lane, such as without signaling) at a particular time. Sensor data collected by UE 107 may indicate that impacts, bumps, etc. were detected at the particular time as well. Based on these pieces of information, Vehicle Wear Determination System 109 may infer or determine that vehicle 101 has veered out of a lane, potentially inadvertently, and has traveled on an unpaved or rough road. Further, Vehicle Wear Determination System 109 may accordingly determine that tires, paint, etc. of vehicle 101 have experienced an excess level of wear based on such an occurrence.

In order to make such determinations as to types or degree of wear that vehicle 101 is experiencing, Vehicle Wear Determination System 109 may compare information associated with vehicle 101 (e.g., vehicle information received from vehicle 101 via vehicle OBD port 201, sensor data collected or measured by UE 107, and/or road/route information received from Navigation/Information Source 105) to one or more models that associate such information with wear categories, classifications, etc.

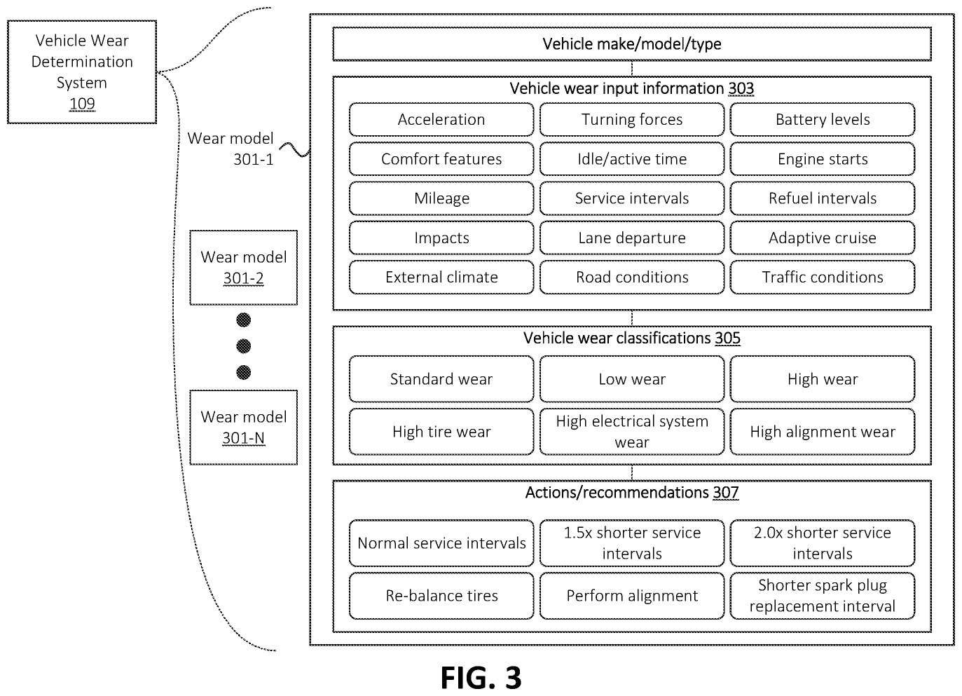

As shown in FIG. 3, for example, Vehicle Wear Determination System 109 may maintain one or more wear models 301 (e.g., vehicle wear models 301-1, 301-2, 301-N, etc.). In some embodiments, each vehicle wear model 301 may be associated with a different make, model, type, or other attribute of vehicle 101. For example, a first vehicle of a first make and model may be associated with a first vehicle wear model 301-1, while a second vehicle of a second make and model may be associated with a second vehicle wear model 301-2. In some embodiments, different criteria or attributes may be used for different vehicle wear models 301, such as temporal criteria (e.g., time of day, day of week, season, etc.), driver criteria (e.g., driver age, quantity of past traffic accidents, or other driver attributes), location-based criteria (e.g., different vehicle wear models 301 may be associated with different cities or states, different types of locations such as urban or suburban, etc.), and/or other suitable criteria.

Each vehicle wear model 301 may, in some embodiments, include a set of vehicle wear information 303, vehicle wear classifications 305, and actions/recommendations 307. Vehicle wear input information 303 for a given vehicle wear model 301 may be considered “inputs” to vehicle wear model 301, while vehicle wear classifications 305 and/or actions/recommendations 307 may be considered “outputs” of vehicle wear model 301. That is, Vehicle Wear Determination System 109 may generate or identify one or more vehicle wear classifications 305 and/or actions/recommendations 307 based on vehicle wear input information 303 received from UE 107 and/or some other source. Vehicle wear input information 303 may, for example, receive training information, feedback information, and/or other suitable information based on which vehicle wear input information 303 may automatically, iteratively, and/or otherwise associate particular sets of vehicle wear input information 303 with particular vehicle wear classifications 305 and/or actions/recommendations 307. For example, vehicle wear input information 303 may utilize AI/ML techniques or other suitable techniques to associate particular sets of vehicle wear input information 303 with particular vehicle wear classifications 305 and/or actions/recommendations 307.

In this manner, since different vehicle wear models 301 may be associated with different criteria (e.g., different makes and/or models of cars, different driver profiles, different times, different locations, etc.), the same or similar set of inputs (e.g., vehicle wear input information 303) may yield different outputs (e.g., vehicle wear classifications 305 and/or 307). As one example, assume that a first vehicle wear model 301-1 is associated with a pickup truck, while a second vehicle wear model 301-2 is associated with a sports coupe. Similar inputs, such as inputs indicating impacts with obstacles, potholes, etc. on the same stretch of road may have different effects on the determination of wear on such vehicles. For example, vehicle wear model 301-1, associated with the pickup truck, may indicate that such impacts have a minimal or no effect on vehicle wear of the pickup truck, whereas vehicle wear model 301-2, associated with the sports coupe, may indicate that such impacts have a substantial effect on vehicle wear of the sports coupe.

Examples of different vehicle wear input information 303 are provided in FIG. 3, and are discussed above. In practice, vehicle wear input information 303 may include different information elements, additional information elements, and/or fewer information elements. Further, in some embodiments, different vehicle wear models 301 may include different information elements than each other (e.g., not all vehicles may be equipped with lane departure sensing devices, etc.).

The training, refining, etc. of a given vehicle wear model 301 may include associating different sets of values associated with different information elements of vehicle wear input information 303 with different vehicle wear classifications 305 and/or actions/recommendations 307. For example, a first set of values of acceleration, mileage, and turning forces for a given vehicle wear model 301 may be associated with a first vehicle wear classification 305 (e.g., “standard wear”), while a second set of values of acceleration, mileage, and turning forces (e.g., higher acceleration, higher mileage, higher turning forces, etc.) for the same vehicle wear model 301 may be associated with a second vehicle wear classification 305 (e.g., “high wear”). Further, as noted above, particular sets of values of vehicle wear input information 303 may be associated with different types of vehicle wear classifications 305. For example, relatively high values for turning forces (e.g., an information element of vehicle wear input information 303) may be associated with a “high tire wear” vehicle wear classification 305. In some embodiments, one set of values for vehicle wear input information 303 may be associated with multiple vehicle wear classifications 305 (e.g., may be associated with a “high tire wear” and “high alignment wear” classification).

In some embodiments, different actions/recommendations 307 may be associated with different vehicle wear classifications 305. For example, a given vehicle 101 for which a “standard wear” vehicle wear classification 305 has been determined may be associated with a “normal service intervals” action/recommendation 307. For example, vehicle 101 may be associated with a default or standard service interval (e.g., every 5,000 miles, every 20,000 miles, every year, etc.), and certain vehicle wear classifications 305 may indicate that no change should be recommended. On the other hand, vehicles that are driven harder or in more adverse conditions (e.g., associated with a “high wear,” “high electrical system wear,” “high alignment wear,” etc. vehicle wear classification 305) may be associated with more frequent service intervals (e.g., “1.5× shorter service intervals,” “2.0× shorter service intervals,” etc.). As another example, a given vehicle 101 that is associated with a “high tire wear” vehicle wear classification 305 may be associated with a “re-balance tires” action/recommendation 307.

In this manner, Vehicle Wear Determination System 109 may collect a holistic view of vehicle 101 from multiple different sources, including from vehicle 101 itself, one or more UEs 107 that are located within vehicle 101 while vehicle 101 is operating, one or more remote sources (e.g., Navigation/Information Source 105), etc. Vehicle Wear Determination System 109 may, based on information from all of these sources in addition to models refined using AI/ML techniques (e.g., which may be refined based on “crowdsourced” real-world data and feedback and/or simulations), identify particular types of wear on vehicle 101 as well as actions that may be taken to remedy or preemptively prevent issues due to the identified types of wear. As such, an unprecedented level of insight may be provided as to how to maintain a vehicle, as well as how to determine whether a vehicle has been subjected to excessive wear and may therefore be devalued and/or in need of maintenance or repair. Further, based on vehicle wear classifications 305 and/or actions/recommendations 307 determined by Vehicle Wear Determination System 109, Vehicle Wear Determination System 109 may generate or determine real-time metrics relating to wear, based on which a vehicle owner or other entity may be able to perform or schedule maintenance, adjust driving habits, or otherwise mitigate wear that vehicle 101 has been subjected to.

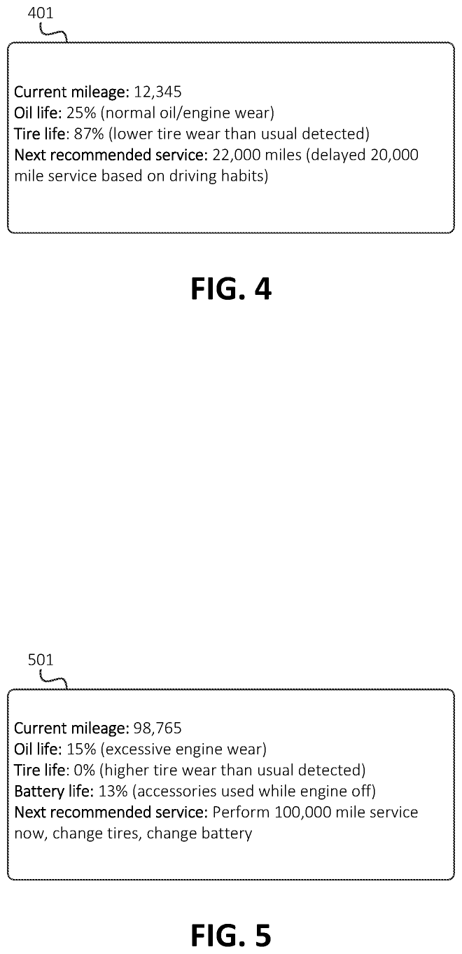

FIG. 4 illustrates an example graphical user interface (“GUI”) 401 that may be presented to a user (e.g., via an application executing on UE 107 and/or on some other suitable device) based on operations described above. For example, Vehicle Wear Determination System 109 may provide some or all of the information shown in FIG. 4, and/or UE 107 may receive portions of such information from other sources (e.g., from vehicle 101 via vehicle OBD port 201 and/or OBD monitor 103). For example, GUI 401 may include a current mileage of vehicle 101, an oil life indicator, a tire life indicator, and a recommendation of a next service for vehicle 101. In some embodiments, as noted above, metrics such as oil life and tire life may be determined based on vehicle wear input information 303 (and/or vehicle wear classifications 305 determined based on vehicle wear input information 303) associated with vehicle 101. For example, that oil or engine wear of vehicle 101 is within a normal or default set of parameters (e.g., few or no redlines, a relatively nominal or minimal amount of stop and go traffic, etc.), and therefore may calculate the oil life as a function of mileage according to such default set of parameters. Further, Vehicle Wear Determination System 109 may provide, via GUI 401, an indication that the wear on the oil or engine of vehicle 101 is “normal,” which may be based on a particular vehicle wear classification 305 determined based on vehicle wear input information 303 associated with vehicle 101.

As another example, GUI 401 may indicate a tire life of vehicle 101, which may be based on one or more vehicle wear classifications 305 determined based on vehicle wear input information 303 (e.g., a “low tire wear” vehicle wear classification 305) and may further be a function of the mileage driven. That is, even if a relatively high number of miles have been driven, the tire life may remain relatively high if wear is relatively low. For example, vehicle wear input information 303 may indicate relatively low turning forces, relatively few turns, driving on well-paved roads, etc., based on which Vehicle Wear Determination System 109 may determine that the tire wear of vehicle 101 is relatively low. Vehicle Wear Determination System 109 may accordingly indicate, via GUI 401, that relatively lower tire wear has been detected (e.g., as compared to a particular vehicle wear model 301 associated with the same vehicle 101). In other words, vehicle wear model 301 may, for example, indicate that most other vehicles 101 of the same make and model experience more tire wear than the particular vehicle 101 to which GUI 401 pertains.

GUI 401 may also include an indication that a next recommended service is at 22,000 miles (e.g., in approximately 10,000 more miles). This indication may be based on, for example, a determined action/recommendation 307 indicating a lesser service interval due to a relatively lower amount of wear associated with vehicle 101. In this manner, an owner of vehicle 101 may be able to save time and/or other resources by virtue of delaying the service interval of vehicle 101, without negatively impacting the operation of vehicle 101.

FIG. 5 illustrates another example GUI 501 that may be presented by Vehicle Wear Determination System 109 based on vehicle wear input information 303 associated with another vehicle 101. In this example, Vehicle Wear Determination System 109 may have detected excessive engine wear and tire wear based on driving habits of vehicle 101 (e.g., as indicated by vehicle wear input information 303). In this example, Vehicle Wear Determination System 109 may have also determined that a battery life of vehicle 101 is relatively low, as a function of time and/or mileage, voltages reported via vehicle OBD port 201, comfort accessory usage reported by vehicle OBD port 201 (e.g., use of radio, climate controls, etc. while an engine of vehicle 101 is off), and/or other criteria. GUI 501 may further indicate multiple actions/recommendations 307 determined based on the above information. For example, Vehicle Wear Determination System 109 may gave determined that a 100,000 mile service should be performed early, that tires should be changed, and that the battery of vehicle 101 should be replaced (e.g., in the event that the 100,000 mile service does not already include a tire change and battery replacement).

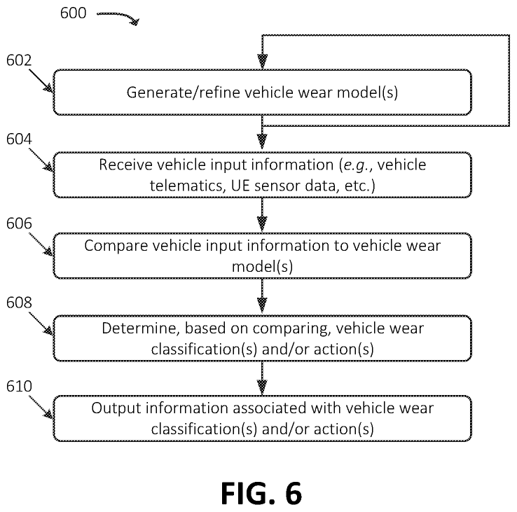

FIG. 6 illustrates an example process 600 for using one or more models to determine a measure of vehicle wear based on vehicle information and/or other types of information. In some embodiments, some or all of process 600 may be performed by Vehicle Wear Determination System 109. In some embodiments, one or more other devices may perform some or all of process 600 in concert with, and/or in lieu of, Vehicle Wear Determination System 109.

As shown, process 600 may include generating and/or refining (at 602) a set of vehicle wear models 301. For example, as discussed above, Vehicle Wear Determination System 109 may receive training data, feedback data (e.g., indicating whether respective determined vehicle wear classifications 305 and/or actions/recommendations 307 were correct or incorrect), and/or other suitable information based on which Vehicle Wear Determination System 109 and/or some other device or system may generate or refine such vehicle wear models 301 using AI/ML techniques or other suitable techniques. As discussed above, vehicle wear models 301 may associate respective sets of vehicle wear input information 303 (e.g., different values for different information elements of vehicle wear input information 303) with different vehicle wear classifications 305 and/or actions/recommendations 307.

Process 600 may further include receiving (at 604) a set of vehicle wear input information 303 associated with a particular vehicle 101. For example, as discussed above, vehicle wear input information 303 may be received from a particular UE 107 or other suitable source. Vehicle wear input information 303 may include sensor data collected or measured by UE 107 (e.g., while UE 107 has determined that UE 107 is within vehicle 101 and/or that vehicle 101 is in operational status), vehicle information provided by vehicle 101 (e.g., telematics, diagnostics, log information, etc.) via vehicle OBD port 201 or some other suitable interface, and/or some other source (e.g., Navigation/Information Source 105 or some other device or system). As discussed above, vehicle wear input information 303 may include raw data, processed and/or classified data (e.g., detected events such as impacts, heavy traffic, construction zones, hard turning, etc.), and/or other suitable information. The received information may include timestamps and/or other suitable key information based on which Vehicle Wear Determination System 109 may “stitch” together information from different sources in order to gain a holistic view of events, attributes, etc. that may affect wear and tear on vehicle 101. For example, based on information from multiple sources (e.g., from UE 107 and vehicle 101, from UE 107 and Navigation/Information Source 105, from Navigation/Information Source 105 and vehicle 101, etc.), Vehicle Wear Determination System 109 may identify one or more events or occurrences (e.g., an impact, a traffic slowdown, etc.), and/or may identify such events or occurrences with a higher confidence level than if such information was received from only one source.

Process 600 may additionally include comparing (at 606) the received vehicle wear input information 303 to some or all of the vehicle wear models 301. For example, Vehicle Wear Determination System 109 may select a particular vehicle wear model 301 (and/or one or more vehicle wear models 301) that pertain to the received vehicle wear input information 303, such as a particular vehicle wear model 301 that is associated with a same vehicle type (e.g., make, model, classification, etc.) as vehicle 101, that is associated with a same timeframe as vehicle wear input information 303 (e.g., same day of week, same time of day, etc.), that is associated with a same driver profile or type (e.g., where vehicle 101 may be associated with a particular driver or driver profile), and/or is otherwise associated with vehicle wear input information 303 and/or vehicle 101. Vehicle Wear Determination System 109 may analyze particular values of the received vehicle wear input information 303 to identify the same or similar values (e.g., “matching” values) of vehicle wear model 301.

Process 600 may also include determining (at 608), based on the comparing, vehicle wear classifications 305 and/or actions/recommendations 307. For example, Vehicle Wear Determination System 109 may identify, based on comparing particular values of vehicle wear input information 303 to particular values of vehicle wear model 301, which particular vehicle wear classifications 305 and/or actions/recommendations 307 are associated with the received vehicle wear input information 303. For example, as discussed above, vehicle wear model 301 may associate particular sets of values of vehicle wear input information 303 to particular vehicle wear classifications 305 and/or actions/recommendations 307, of which Vehicle Wear Determination System 109 may identify or select one or more particular vehicle wear classifications 305 and/or actions/recommendations 307 that are associated with the received vehicle wear input information 303 associated with vehicle 101. As discussed above, the actions may include recommendations and/or other information indicating maintenance, repairs, etc. Additionally, or alternatively, the actions may include providing alerts, reports, etc. regarding particular types of determined vehicle wear and/or a degree to which wear on vehicle 101 has been identified.

Process 600 may further include outputting (at 610) information associated with vehicle wear classifications 305 and/or actions/recommendations 307. For example, Vehicle Wear Determination System 109 may output such information to UE 107, from which some or all of vehicle wear input information 303 associated with vehicle 101 was received. UE 107 may present such information in a user interface (e.g., GUI 401, GUI 501, etc.). As such, a user of UE 107 (e.g., an owner or driver of vehicle 101 and/or some other suitable entity) may gain insight as to how worn vehicle 101 is, as compared to a “normal” or “average” level of wear. Further such user may be able to perform maintenance or repairs that the user would have otherwise not been aware of. Additionally, such user may avoid performing excessive maintenance or repairs in situations where lower than expected wear on vehicle 101 has occurred.

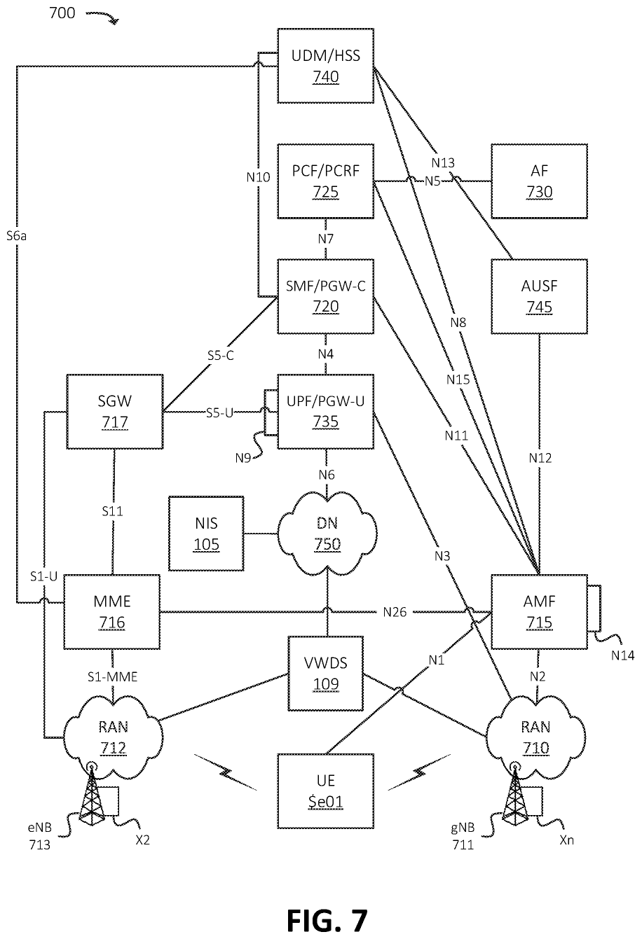

FIG. 7 illustrates an example environment 700, in which one or more embodiments may be implemented. In some embodiments, environment 700 may correspond to a Fifth Generation (“5G”) network, and/or may include elements of a 5G network. In some embodiments, environment 700 may correspond to a 5G Non-Standalone (“NSA”) architecture, in which a 5G radio access technology (“RAT”) may be used in conjunction with one or more other RATs (e.g., a Long-Term Evolution (“LTE”) RAT), and/or in which elements of a 5G core network may be implemented by, may be communicatively coupled with, and/or may include elements of another type of core network (e.g., an evolved packet core (“EPC”)). In some embodiments, portions of environment 700 may represent or may include a 5G core (“5GC”). As shown, environment 700 may include UE 701, RAN 710 (which may include one or more Next Generation Node Bs (“gNBs”) 711), RAN 712 (which may include one or more evolved Node Bs (“eNBs”) 713), and various network functions such as Access and Mobility Management Function (“AMF”) 715, Mobility Management Entity (“MME”) 716, Serving Gateway (“SGW”) 717, Session Management Function (“SMF”)/Packet Data Network (“PDN”) Gateway (“PGW”)-Control plane function (“PGW-C”) 720, Policy Control Function (“PCF”)/Policy Charging and Rules Function (“PCRF”) 725, Application Function (“AF”) 730, User Plane Function (“UPF”)/PGW-User plane function (“PGW-U”) 735, Unified Data Management (“UDM”)/Home Subscriber Server (“HSS”) 740, and Authentication Server Function (“AUSF”) 745. Environment 700 may also include one or more networks, such as Data Network (“DN”) 750. Environment 700 may include one or more additional devices or systems communicatively coupled to one or more networks (e.g., DN 750), such as Navigation/Information Source 105, Vehicle Wear Determination System 109, and/or one or more other devices or systems.

The example shown in FIG. 7 illustrates one instance of each network component or function (e.g., one instance of SMF/PGW-C 720, PCF/PCRF 725, UPF/PGW-U 735, UDM/HSS 740, and/or AUSF 745). In practice, environment 700 may include multiple instances of such components or functions. For example, in some embodiments, environment 700 may include multiple “slices” of a core network, where each slice includes a discrete and/or logical set of network functions (e.g., one slice may include a first instance of SMF/PGW-C 720, PCF/PCRF 725, UPF/PGW-U 735, UDM/HSS 740, and/or AUSF 745, while another slice may include a second instance of SMF/PGW-C 720, PCF/PCRF 725, UPF/PGW-U 735, UDM/HSS 740, and/or AUSF 745). The different slices may provide differentiated levels of service, such as service in accordance with different Quality of Service (“QoS”) parameters.

The quantity of devices and/or networks, illustrated in FIG. 7, is provided for explanatory purposes only. In practice, environment 700 may include additional devices and/or networks, fewer devices and/or networks, different devices and/or networks, or differently arranged devices and/or networks than illustrated in FIG. 7. For example, while not shown, environment 700 may include devices that facilitate or enable communication between various components shown in environment 700, such as routers, modems, gateways, switches, hubs, etc. In some implementations, one or more devices of environment 700 may be physically integrated in, and/or may be physically attached to, one or more other devices of environment 700. Alternatively, or additionally, one or more of the devices of environment 700 may perform one or more network functions described as being performed by another one or more of the devices of environment 700.

Elements of environment 700 may interconnect with each other and/or other devices via wired connections, wireless connections, or a combination of wired and wireless connections. Examples of interfaces or communication pathways between the elements of environment 700, as shown in FIG. 7, may include an N1 interface, an N2 interface, an N3 interface, an N4 interface, an N5 interface, an N6 interface, an N7 interface, an N8 interface, an N9 interface, an N10 interface, an N11 interface, an N12 interface, an N13 interface, an N14 interface, an N2 interface, an N26 interface, an S1-C interface, an S1-U interface, an S5-C interface, an S5-U interface, an S6a interface, an S11 interface, and/or one or more other interfaces. Such interfaces may include interfaces not explicitly shown in FIG. 7, such as Service-Based Interfaces (“SBIs”), including an Namf interface, an Nudm interface, an Npcf interface, an Nupf interface, an Nnef interface, an Nsmf interface, and/or one or more other SBIs. In some embodiments, environment 700 may be, may include, may be implemented by, and/or may be communicatively coupled to network 203.

UE 701 may include a computation and communication device, such as a wireless mobile communication device that is capable of communicating with RAN 710, RAN 712, and/or DN 750. UE 701 may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an Internet of Things (“IoT”) device (e.g., a sensor, a smart home appliance, a wearable device, a Machine-to-Machine (“M2M”) device, or the like), or another type of mobile computation and communication device. UE 701 may send traffic to and/or receive traffic (e.g., user plane traffic) from DN 750 via RAN 710, RAN 712, and/or UPF/PGW-U 735.

RAN 710 may be, or may include, a 5G RAN that includes one or more base stations (e.g., one or more gNBs 711), via which UE 701 may communicate with one or more other elements of environment 700. UE 701 may communicate with RAN 710 via an air interface (e.g., as provided by gNB 711). For instance, RAN 710 may receive traffic (e.g., user plane traffic such as voice call traffic, data traffic, messaging traffic, etc.) from UE 701 via the air interface, and may communicate the traffic to UPF/PGW-U 735 and/or one or more other devices or networks. Further, RAN 710 may receive signaling traffic, control plane traffic, etc. from UE 701 via the air interface, and may communicate such signaling traffic, control plane traffic, etc. to AMF 715 and/or one or more other devices or networks. Additionally, RAN 710 may receive traffic intended for UE 701 (e.g., from UPF/PGW-U 735, AMF 715, and/or one or more other devices or networks) and may communicate the traffic to UE 701 via the air interface.

RAN 712 may be, or may include, a LTE RAN that includes one or more base stations (e.g., one or more eNBs 713), via which UE 701 may communicate with one or more other elements of environment 700. UE 701 may communicate with RAN 712 via an air interface (e.g., as provided by eNB 713). For instance, RAN 712 may receive traffic (e.g., user plane traffic such as voice call traffic, data traffic, messaging traffic, signaling traffic, etc.) from UE 701 via the air interface, and may communicate the traffic to UPF/PGW-U 735 (e.g., via SGW 717) and/or one or more other devices or networks. Further, RAN 712 may receive signaling traffic, control plane traffic, etc. from UE 701 via the air interface, and may communicate such signaling traffic, control plane traffic, etc. to MME 716 and/or one or more other devices or networks. Additionally, RAN 712 may receive traffic intended for UE 701 (e.g., from UPF/PGW-U 735, MME 716, SGW 717, and/or one or more other devices or networks) and may communicate the traffic to UE 701 via the air interface.

AMF 715 may include one or more devices, systems, Virtualized Network Functions (“VNFs”), Cloud-Native Network Functions (“CNFs”), etc., that perform operations to register UE 701 with the 5G network, to establish bearer channels associated with a session with UE 701, to hand off UE 701 from the 5G network to another network, to hand off UE 701 from the other network to the 5G network, manage mobility of UE 701 between RANs 710 and/or gNBs 711, and/or to perform other operations. In some embodiments, the 5G network may include multiple AMFs 715, which communicate with each other via the N14 interface (denoted in FIG. 7 by the line marked “N14” originating and terminating at AMF 715).

MME 716 may include one or more devices, systems, VNFs, CNFs, etc., that perform operations to register UE 701 with the EPC, to establish bearer channels associated with a session with UE 701, to hand off UE 701 from the EPC to another network, to hand off UE 701 from another network to the EPC, manage mobility of UE 701 between RANs 712 and/or eNBs 713, and/or to perform other operations.

SGW 717 may include one or more devices, systems, VNFs, CNFs, etc., that aggregate traffic received from one or more eNBs 713 and send the aggregated traffic to an external network or device via UPF/PGW-U 735. Additionally, SGW 717 may aggregate traffic received from one or more UPF/PGW-Us 735 and may send the aggregated traffic to one or more eNBs 713. SGW 717 may operate as an anchor for the user plane during inter-eNB handovers and as an anchor for mobility between different telecommunication networks or RANs (e.g., RANs 710 and 712).

SMF/PGW-C 720 may include one or more devices, systems, VNFs, CNFs, etc., that gather, process, store, and/or provide information in a manner described herein. SMF/PGW-C 720 may, for example, facilitate the establishment of communication sessions on behalf of UE 701. In some embodiments, the establishment of communications sessions may be performed in accordance with one or more policies provided by PCF/PCRF 725.

PCF/PCRF 725 may include one or more devices, systems, VNFs, CNFs, etc., that aggregate information to and from the 5G network and/or other sources. PCF/PCRF 725 may receive information regarding policies and/or subscriptions from one or more sources, such as subscriber databases and/or from one or more users (such as, for example, an administrator associated with PCF/PCRF 725).

AF 730 may include one or more devices, systems, VNFs, CNFs, etc., that receive, store, and/or provide information that may be used in determining parameters (e.g., quality of service parameters, charging parameters, or the like) for certain applications.

UPF/PGW-U 735 may include one or more devices, systems, VNFs, CNFs, etc., that receive, store, and/or provide data (e.g., user plane data). For example, UPF/PGW-U 735 may receive user plane data (e.g., voice call traffic, data traffic, etc.), destined for UE 701, from DN 750, and may forward the user plane data toward UE 701 (e.g., via RAN 710, SMF/PGW-C 720, and/or one or more other devices). In some embodiments, multiple UPFs 735 may be deployed (e.g., in different geographical locations), and the delivery of content to UE 701 may be coordinated via the N9 interface (e.g., as denoted in FIG. 7 by the line marked “N9” originating and terminating at UPF/PGW-U 735). Similarly, UPF/PGW-U 735 may receive traffic from UE 701 (e.g., via RAN 710, RAN 712, SMF/PGW-C 720, and/or one or more other devices), and may forward the traffic toward DN 750. In some embodiments, UPF/PGW-U 735 may communicate (e.g., via the N4 interface) with SMF/PGW-C 720, regarding user plane data processed by UPF/PGW-U 735.

UDM/HSS 740 and AUSF 745 may include one or more devices, systems, VNFs, CNFs, etc., that manage, update, and/or store, in one or more memory devices associated with AUSF 745 and/or UDM/HSS 740, profile information associated with a subscriber. AUSF 745 and/or UDM/HSS 740 may perform authentication, authorization, and/or accounting operations associated with the subscriber and/or a communication session with UE 701.

DN 750 may include one or more wired and/or wireless networks. For example, DN 750 may include an Internet Protocol (“IP”)-based PDN, a wide area network (“WAN”) such as the Internet, a private enterprise network, and/or one or more other networks. UE 701 may communicate, through DN 750, with data servers, other UEs 701, and/or to other servers or applications that are coupled to DN 750. DN 750 may be connected to one or more other networks, such as a public switched telephone network (“PSTN”), a public land mobile network (“PLMN”), and/or another network. DN 750 may be connected to one or more devices, such as content providers, applications, web servers, and/or other devices, with which UE 701 may communicate.

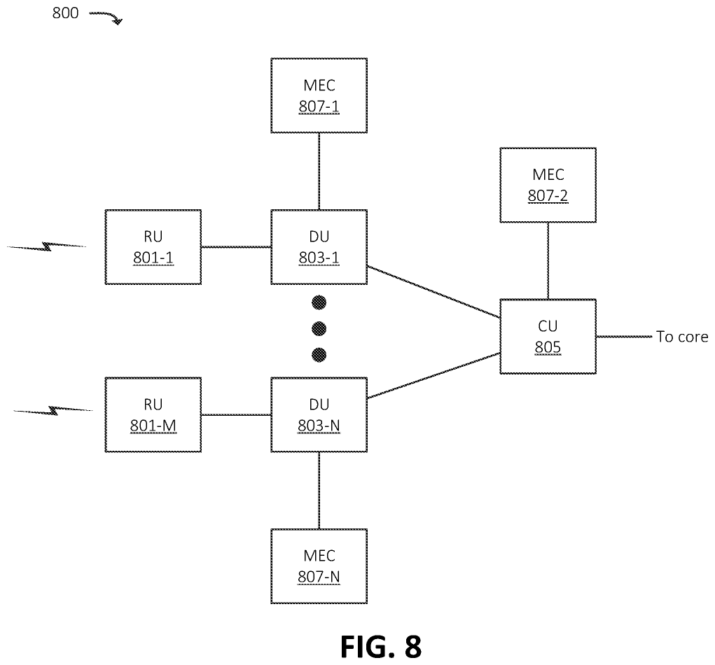

FIG. 8 illustrates an example RAN environment 800, which may be included in and/or implemented by one or more RANs (e.g., RAN 710, RAN 712, or some other RAN). In some embodiments, a particular RAN may include one RAN environment 800. In some embodiments, a particular RAN may include multiple RAN environments 800. In some embodiments, RAN environment 800 may correspond to a particular gNB 711 of a 5G RAN (e.g., RAN 710). In some embodiments, RAN environment 800 may correspond to multiple gNBs 711. In some embodiments, RAN environment 800 may correspond to one or more other types of base stations of one or more other types of RANs. As shown, RAN environment 800 may include Central Unit (“CU”) 805, one or more Distributed Units (“DUs”) 803-1 through 803-N (referred to individually as “DU 803,” or collectively as “DUs 803”), and one or more Radio Units (“RUs”) 801-1 through 801-M (referred to individually as “RU 801,” or collectively as “RUs 801”).

CU 805 may communicate with a core of a wireless network (e.g., may communicate with one or more of the devices or systems described above with respect to FIG. 7, such as AMF 715 and/or UPF/PGW-U 735). In the uplink direction (e.g., for traffic from UEs 701 to a core network), CU 805 may aggregate traffic from DUs 803, and forward the aggregated traffic to the core network. In some embodiments, CU 805 may receive traffic according to a given protocol (e.g., Radio Link Control (“RLC”)) from DUs 803, and may perform higher-layer processing (e.g., may aggregate/process RLC packets and generate Packet Data Convergence Protocol (“PDCP”) packets based on the RLC packets) on the traffic received from DUs 803.

In accordance with some embodiments, CU 805 may receive downlink traffic (e.g., traffic from the core network) for a particular UE 701, and may determine which DU(s) 803 should receive the downlink traffic. DU 803 may include one or more devices that transmit traffic between a core network (e.g., via CU 805) and UE 701 (e.g., via a respective RU 801). DU 803 may, for example, receive traffic from RU 801 at a first layer (e.g., physical (“PHY”) layer traffic, or lower PHY layer traffic), and may process/aggregate the traffic to a second layer (e.g., upper PHY and/or RLC). DU 803 may receive traffic from CU 805 at the second layer, may process the traffic to the first layer, and provide the processed traffic to a respective RU 801 for transmission to UE 701.

RU 801 may include hardware circuitry (e.g., one or more RF transceivers, antennas, radios, and/or other suitable hardware) to communicate wirelessly (e.g., via an RF interface) with one or more UEs 701, one or more other DUs 803 (e.g., via RUs 801 associated with DUs 803), and/or any other suitable type of device. In the uplink direction, RU 801 may receive traffic from UE 701 and/or another DU 803 via the RF interface and may provide the traffic to DU 803. In the downlink direction, RU 801 may receive traffic from DU 803, and may provide the traffic to UE 701 and/or another DU 803.

One or more elements of RAN environment 800 may, in some embodiments, be communicatively coupled to one or more Multi-Access/Mobile Edge Computing (“MEC”) devices, referred to sometimes herein simply as “MECs” 807. For example, DU 803-1 may be communicatively coupled to MEC 807-1, DU 803-N may be communicatively coupled to MEC 807-N, CU 805 may be communicatively coupled to MEC 807-2, and so on. MECs 807 may include hardware resources (e.g., configurable or provisionable hardware resources) that may be configured to provide services and/or otherwise process traffic to and/or from UE 701, via a respective RU 801.

For example, DU 803-1 may route some traffic, from UE 701, to MEC 807-1 instead of to a core network via CU 805. MEC 807-1 may process the traffic, perform one or more computations based on the received traffic, and may provide traffic to UE 701 via RU 801-1. In some embodiments, MEC 807 may include, and/or may implement, some or all of the functionality described above with respect to Navigation/Information Source 105, Vehicle Wear Determination System 109, AF 730, UPF 735, and/or one or more other devices, systems, VNFs, CNFs, etc. In this manner, ultra-low latency services may be provided to UE 701, as traffic does not need to traverse DU 803, CU 805, links between DU 803 and CU 805, and an intervening backhaul network between RAN environment 800 and the core network.

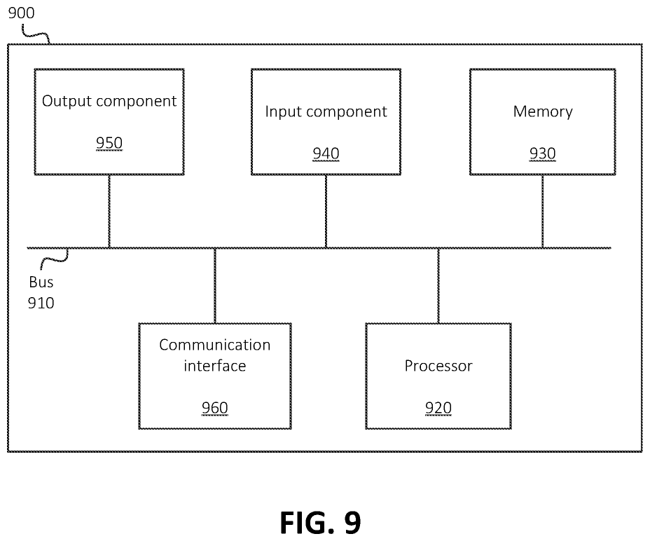

FIG. 9 illustrates example components of device 900. One or more of the devices described above may include one or more devices 900. Device 900 may include bus 910, processor 920, memory 930, input component 940, output component 950, and communication interface 960. In another implementation, device 900 may include additional, fewer, different, or differently arranged components.

Bus 910 may include one or more communication paths that permit communication among the components of device 900. Processor 920 may include a processor, microprocessor, or processing logic that may interpret and execute instructions. In some embodiments, processor 920 may be or may include one or more hardware processors. Memory 930 may include any type of dynamic storage device that may store information and instructions for execution by processor 920, and/or any type of non-volatile storage device that may store information for use by processor 920.

Input component 940 may include a mechanism that permits an operator to input information to device 900 and/or other receives or detects input from a source external to input component 940, such as a touchpad, a touchscreen, a keyboard, a keypad, a button, a switch, a microphone or other audio input component, etc. In some embodiments, input component 940 may include, or may be communicatively coupled to, one or more sensors, such as a motion sensor (e.g., which may be or may include a gyroscope, accelerometer, or the like), a location sensor (e.g., a Global Positioning System (“GPS”)-based location sensor or some other suitable type of location sensor or location determination component), a thermometer, a barometer, and/or some other type of sensor. Output component 950 may include a mechanism that outputs information to the operator, such as a display, a speaker, one or more light emitting diodes (“LEDs”), etc.

Communication interface 960 may include any transceiver-like mechanism that enables device 900 to communicate with other devices and/or systems. For example, communication interface 960 may include an Ethernet interface, an optical interface, a coaxial interface, or the like. Communication interface 960 may include a wireless communication device, such as an infrared (“IR”) receiver, a Bluetooth® radio, or the like. The wireless communication device may be coupled to an external device, such as a remote control, a wireless keyboard, a mobile telephone, etc. In some embodiments, device 900 may include more than one communication interface 960. For instance, device 900 may include an optical interface and an Ethernet interface.

Device 900 may perform certain operations relating to one or more processes described above. Device 900 may perform these operations in response to processor 920 executing software instructions stored in a computer-readable medium, such as memory 930. A computer-readable medium may be defined as a non-transitory memory device. A memory device may include space within a single physical memory device or spread across multiple physical memory devices. The software instructions may be read into memory 930 from another computer-readable medium or from another device. The software instructions stored in memory 930 may cause processor 920 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1-6), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A device, comprising:
a non-transitory computer-readable medium storing a plurality of processor-executable instructions; and
one or more processors configured to execute the plurality of processor-executable instructions, wherein executing the plurality of processor-executable instructions causes the one or more processors to:
maintain one or more models associating respective sets of vehicle input information with respective vehicle wear classifications;
maintain information associating one or more respective actions with each of the vehicle wear classifications;
receive a particular set of vehicle input information associated with a particular vehicle, wherein the vehicle input information includes at least one of:
sensor data measured by one or more User Equipment (“UEs”), or
vehicle information provided by the particular vehicle;
compare the received particular set of vehicle input to the one or more models associating the respective sets of vehicle input information with respective vehicle wear classifications;
determine, based on the comparing, one or more vehicle wear classifications associated with the particular vehicle;
identify, based on the information associating the one or more respective actions with the vehicle wear classifications, one or more actions associated with the determined one or more vehicle wear classifications; and
output, to the one or more UEs, information indicating the identified one or more actions.

2. The device of claim 1, wherein the received particular set of vehicle input information includes:
the sensor data measured by the one or more UEs. and
the vehicle information provided by the particular vehicle.

3. The device of claim 2, wherein executing the plurality of processor-executable instructions further causes the one or more processors to:
identify a portion of the sensor data measured by the one or more UEs that is associated with a particular timeframe; and
identify a portion of the vehicle information, provided by the particular vehicle, that is associated with the same particular timeframe,
wherein determining the one or more vehicle wear classifications associated with the particular vehicle is further based on the portion of the sensor data and the portion of the vehicle information associated with the particular timeframe.

4. The device of claim 3, wherein executing the plurality of processor-executable instructions further causes the one or more processors to:
identify one or more events that occurred during the particular timeframe based on the portion of the sensor data and the portion of the vehicle information associated with the particular timeframe,
wherein determining the one or more vehicle wear classifications associated with the particular vehicle is further based on the identified one or more events that occurred during with the particular timeframe.

5. The device of claim 1, wherein the sensor data measured by the one or more UEs includes:
sensor data measured by the one or more UEs while the one or more UEs are located within the particular vehicle, or
sensor data measured by the one or more UEs while the particular vehicle is operational.

6. The device of claim 1, wherein executing the plurality of processor-executable instructions further causes the one or more processors to:
maintain a plurality of models, including the one or more models, that are each associated with a respective vehicle type,
receive, from the UE, an indication of a particular vehicle type of the particular vehicle; and
select the one or more models from the plurality of models based on identifying that the one or more models are associated with the particular vehicle type of the particular vehicle.

7. The device of claim 1, wherein executing the plurality of processor-executable instructions further causes the one or more processors to:
generate or refine the one or more models using artificial intelligence/machine learning (“AI/ML”) techniques.

8. A non-transitory computer-readable medium, storing a plurality of processor-executable instructions to:
maintain one or more models associating respective sets of vehicle input information with respective vehicle wear classifications;
maintain information associating one or more respective actions with each of the vehicle wear classifications;
receive a particular set of vehicle input information associated with a particular vehicle, wherein the vehicle input information includes at least one of:
sensor data measured by one or more User Equipment (“UEs”), or
vehicle information provided by the particular vehicle;
compare the received particular set of vehicle input to the one or more models associating the respective sets of vehicle input information with respective vehicle wear classifications;
determine, based on the comparing, one or more vehicle wear classifications associated with the particular vehicle;
identify, based on the information associating the one or more respective actions with the vehicle wear classifications, one or more actions associated with the determined one or more vehicle wear classifications; and
output, to the one or more UEs, information indicating the identified one or more actions.

9. The non-transitory computer-readable medium of claim 8, wherein the received particular set of vehicle input information includes:
the sensor data measured by the one or more UEs. and
the vehicle information provided by the particular vehicle.

10. The non-transitory computer-readable medium of claim 9, wherein the plurality of processor-executable instructions further include processor-executable instructions to:
identify a portion of the sensor data measured by the one or more UEs that is associated with a particular timeframe; and
identify a portion of the vehicle information, provided by the particular vehicle, that is associated with the same particular timeframe,
wherein determining the one or more vehicle wear classifications associated with the particular vehicle is further based on the portion of the sensor data and the portion of the vehicle information associated with the particular timeframe.

11. The non-transitory computer-readable medium of claim 10, wherein the plurality of processor-executable instructions further include processor-executable instructions to:
identify one or more events that occurred during the particular timeframe based on the portion of the sensor data and the portion of the vehicle information associated with the particular timeframe,
wherein determining the one or more vehicle wear classifications associated with the particular vehicle is further based on the identified one or more events that occurred during with the particular timeframe.

12. The non-transitory computer-readable medium of claim 8, wherein the sensor data measured by the one or more UEs includes:
sensor data measured by the one or more UEs while the one or more UEs are located within the particular vehicle, or
sensor data measured by the one or more UEs while the particular vehicle is operational.

13. The non-transitory computer-readable medium of claim 8, wherein the plurality of processor-executable instructions further include processor-executable instructions to:
maintain a plurality of models, including the one or more models, that are each associated with a respective vehicle type,
receive, from the UE, an indication of a particular vehicle type of the particular vehicle; and
select the one or more models from the plurality of models based on identifying that the one or more models are associated with the particular vehicle type of the particular vehicle.

14. The non-transitory computer-readable medium of claim 8, wherein the plurality of processor-executable instructions further include processor-executable instructions to:
generate or refine the one or more models using artificial intelligence/machine learning (“AI/ML”) techniques.

15. A method, comprising:
maintaining one or more models associating respective sets of vehicle input information with respective vehicle wear classifications;
maintaining information associating one or more respective actions with each of the vehicle wear classifications;
receiving a particular set of vehicle input information associated with a particular vehicle, wherein the vehicle input information includes at least one of:
sensor data measured by one or more User Equipment (“UEs”), or
vehicle information provided by the particular vehicle;
comparing the received particular set of vehicle input to the one or more models associating the respective sets of vehicle input information with respective vehicle wear classifications;
determining, based on the comparing, one or more vehicle wear classifications associated with the particular vehicle;
identifying, based on the information associating the one or more respective actions with the vehicle wear classifications, one or more actions associated with the determined one or more vehicle wear classifications; and
outputting, to the one or more UEs, information indicating the identified one or more actions.

16. The method of claim 15, wherein the received particular set of vehicle input information includes:
the sensor data measured by the one or more UEs. and
the vehicle information provided by the particular vehicle.

17. The method of claim 16, further comprising:
identifying a portion of the sensor data measured by the one or more UEs that is associated with a particular timeframe; and
identifying a portion of the vehicle information, provided by the particular vehicle, that is associated with the same particular timeframe,
wherein determining the one or more vehicle wear classifications associated with the particular vehicle is further based on the portion of the sensor data and the portion of the vehicle information associated with the particular timeframe.

18. The method of claim 17, further comprising:
identifying one or more events that occurred during the particular timeframe based on the portion of the sensor data and the portion of the vehicle information associated with the particular timeframe,
wherein determining the one or more vehicle wear classifications associated with the particular vehicle is further based on the identified one or more events that occurred during with the particular timeframe.

19. The method of claim 15, wherein the sensor data measured by the one or more UEs includes:
sensor data measured by the one or more UEs while the one or more UEs are located within the particular vehicle, or
sensor data measured by the one or more UEs while the particular vehicle is operational.

20. The method of claim 15, further comprising:
maintaining a plurality of models, including the one or more models, that are each associated with a respective vehicle type,
receiving, from the UE, an indication of a particular vehicle type of the particular vehicle; and
selecting the one or more models from the plurality of models based on identifying that the one or more models are associated with the particular vehicle type of the particular vehicle.
